(19) United States
(12) Patent Application Publication
(10) Pub. No.: US 2017/0149756 A1
(43) Pub. Date: May 25, 2017

(54) AUTHENTICATION SYSTEM, AUTHENTICATION METHOD, AND COMPUTER-READABLE RECORDING MEDIUM

(71) Applicant: Takayuki KUNIEDA, Tokyo (JP)

(72) Inventor: Takayuki KUNIEDA, Tokyo (JP)

(73) Assignee: Ricoh Company, Ltd., Tokyo (JP)

(21) Appl. No.: 15/353,843

(22) Filed: Nov. 17, 2016

(30) Foreign Application Priority Data
Nov. 19, 2015 (JP) 2015-227148

(51) Int. Cl. H04L 29/06; H04N 1/44; H04N 1/32

(52) U.S. Cl. CPC H04L 63/08; H04N 1/32101; H04N 1/4433; H04N 2201/0094; H04N 2201/0039; H04N 2201/0055

(57) ABSTRACT

An authentication system includes a processor configured to perform: generating an image including first identification information for identifying a user and second identification information for identifying a terminal device; extracting the first identification information and the second identification information from image information acquired by reading the image using a reading device; authenticating the first identification information extracted by the extraction unit; and connecting the terminal device to a device via a network based on the extracted second identification information when authentication of the performed first identification information has been successful.

### CROSS-REFERENCE TO RELATED APPLICATIONS

The present application claims priority under 35 U.S.C. §119 to Japanese Patent Application No. 2015-227148 filed Nov. 19, 2015. The contents of which are incorporated herein by reference in their entirety.

### BACKGROUND OF THE INVENTION

1. Field of the Invention

The present invention relates to an authentication system, an authentication method, and a computer-readable recording medium.

2. Description of the Related Art

A technique has been known with which propriety of connection to a network system inside an organization (inside a company, for example) from an information processing device used by a user outside an organization (outside a company, for example) is determined by a user inside the organization based on identification information input by the user outside the organization, which has been notified in advance, and connection permission is manually given to the information processing device (see Japanese Unexamined Patent Application Publication No. 2015-084515, for example). The technique disclosed in Japanese Unexamined Patent Application Publication No. 2015-084515 enables easy connection to a network system inside an organization from an information processing device of a user outside the organization, and at the same time, enables prevention of malicious intrusion into the network system from outside the organization.

However, with the above-described technique disclosed in Japanese Unexamined Patent Application Publication No. 2015-084515, when a plurality of users are present outside the organization, for example, the user inside the organization has to perform processing of giving connection permission to an information processing device of each of the users outside the organization manually with respect to each of the users outside the organization. With this, there has been a risk of increasing the load of the user inside the organization.

In view of the above-described problem, there is a need to enable easy connection to a network system inside an organization from an information processing device of a user outside the organization while maintaining security.

### SUMMARY OF THE INVENTION

According to exemplary embodiments of the present invention, there is provided

Exemplary embodiments of the present invention also provide

Exemplary embodiments of the present invention also provide

### BRIEF DESCRIPTION OF THE DRAWINGS

FIG. 1 is a diagram illustrating an example of the configuration of a network system applicable to a first embodiment of the present invention;

FIG. 2 is a block diagram illustrating an example of the hardware configuration of an authentication device applicable to the first embodiment;

FIG. 3 is a block diagram illustrating an example of the hardware configuration of a server applicable to the first embodiment;

FIG. 4 is a block diagram illustrating an example of the hardware configuration of a terminal device applicable to the first embodiment;

FIG. 5 is a functional block diagram explaining an example of a function of the authentication device according to the first embodiment;

FIG. 6 is a functional block diagram explaining an example of a function of the server according to the first embodiment;

FIG. 7 is a diagram schematically explaining procedures of authentication processing and connection control processing according to the first embodiment;

FIGS. 8A and 8B are each a diagram illustrating an example of information stored in a user DB according to the first embodiment;

FIGS. 9A and 9B are each a diagram illustrating an example of an image for authentication that is displayed on a display unit of the terminal device according to the first embodiment;

FIG. 10 is a flowchart illustrating an example of processing performed in the terminal device according to the first embodiment;

FIG. 11 is a flowchart illustrating an example of authentication processing performed in the authentication device according to the first embodiment;

FIG. 12 is a sequence diagram illustrating an example of more detailed procedures of the authentication processing and the connection control processing according to the first embodiment;

FIG. 13 is a functional block diagram explaining an example of a function of a terminal device according to a second embodiment of the present invention;

FIG. 14 is a diagram schematically explaining procedures of authentication processing and connection control processing according to the second embodiment;

FIG. 15 is a flowchart illustrating an example of processing performed in the terminal device according to the second embodiment;

FIG. 16 is a sequence diagram illustrating an example of more detailed procedures of the authentication processing and the connection control processing according to the second embodiment; and

FIG. 17 is a diagram illustrating an example of the configuration of a network system applicable to a third embodiment of the present invention.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

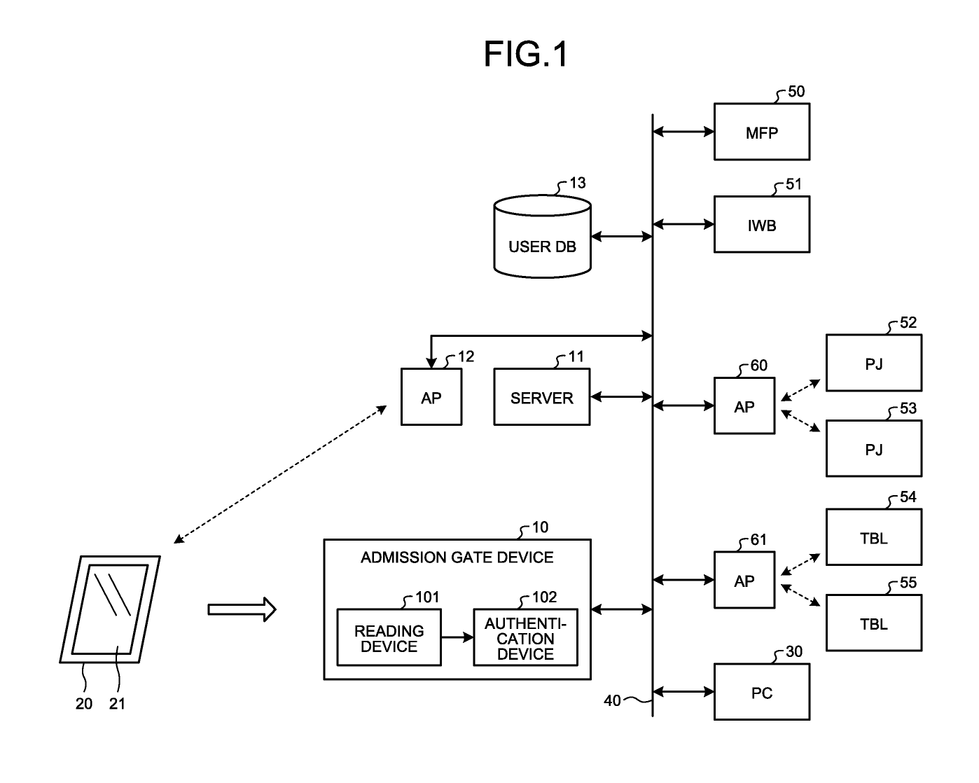

Network system applicable to a first embodiment FIG. 1 is a diagram illustrating an example of the configuration of a network system applicable to a first embodiment of the present invention. A network 40 is a local area network (LAN) that performs communication using, as a protocol, Transmission Control Protocol/Internet Protocol (TCP/IP), for example, which is an in-organization network closed inside an organization such as a company. To the network 40, a plurality of devices such as a multi-function printer (MFP) 50, an interactive whiteboard (IWB) 51, and a personal computer (PC) 30 are inter-communicably connected to one another.

The network 40 herein is installed inside a building managed by an organization (referred to as a company office building), for example.

To the network 40, access points (AP) 60 and 61 are further connected, which are compliant with Institute of Electrical and Electronics Engineers (IEEE) 802.11 standards and based on a wireless LAN. Hereinafter, a wireless LAN compliant with the IEEE 802.11 standards is referred to as Wi-Fi (registered trademark) being the name of an interoperability certification by Wi-Fi Alliance, an industry association related to IEEE 802.11 devices. In the example illustrated in FIG. 1, the AP 60 is enabled to communicate with projector devices (PJs) 52 and 53 each of which complies with Wi-Fi. Furthermore, the AP 61 is enabled to communicate with tablet terminals (TBLs) 54 and 55 each of which also complies with Wi-Fi.

In the configuration described above, information such as an image transmitted from the PC 30 can be output from the MFP 50 and displayed on the IWB 51 via the network 40. Furthermore, information such as an image transmitted from the PC 30 can be projected on a screen (not illustrated) by the PJs 52 and 53 via the network 40 and the AP 60. Furthermore, information transmitted from the TBL 54 and TBL 55 can be transferred to the network 40 via the AP 61 and supplied to the PC 30. Furthermore, information such as an image transmitted from the TBL 54 and TBL 55 can be transferred to the network 40 via the AP 61 and supplied to the MFP 50 and the IWB 51.

To the network 40, an admission gate device 10, a server 11, an AP 12, and a user DB 13 are further connected. The admission gate device 10, for example, performs authentication for admission to a particular building such as a company office building in which management of the organization is executed. The admission gate device 10 includes a reading device 101 that optically reads an image and an authentication device 102 that performs authentication based on image information obtained with the reading device 101 reading the image.

The AP 12 may be installed inside a particular building such as a company office building. Furthermore, authentication performed by the admission gate device 10 may include not only authentication for admission to a particular building but also authentication for a user to enter into a physical area partitioned within a predetermined range. It should be noted that the physical area does not necessarily has to be visually partitioned.

The server 11 performs management of a network system including the network 40. The server 11 may include a single computer or include a plurality of computers operated in conjunction with one another. The AP 12 is an access point for performing communication using a wireless LAN compliant with Wi-Fi (registered trademark) and is an open access point connectable only by inputting a service set identifier (SSID) not requiring authentication processing.

The terminal device 20 is used by a user outside the organization and enabled to perform communication compliant with Wi-Fi. Furthermore, the terminal device 20 includes a display unit 21 that displays an image and an input unit that receives a user operation.

The user DB 13 stores therein information on a user who is enabled to connect to the network 40 using the terminal device 20. The user DB 13 stores therein at least user identification information for identifying the user and device identification information for identifying the terminal device 20 used by the user in an associated manner. The user DB 13 further can store therein the user identification information and attribute information indicating an attribute of the user identified by the user identification information in an associated manner.

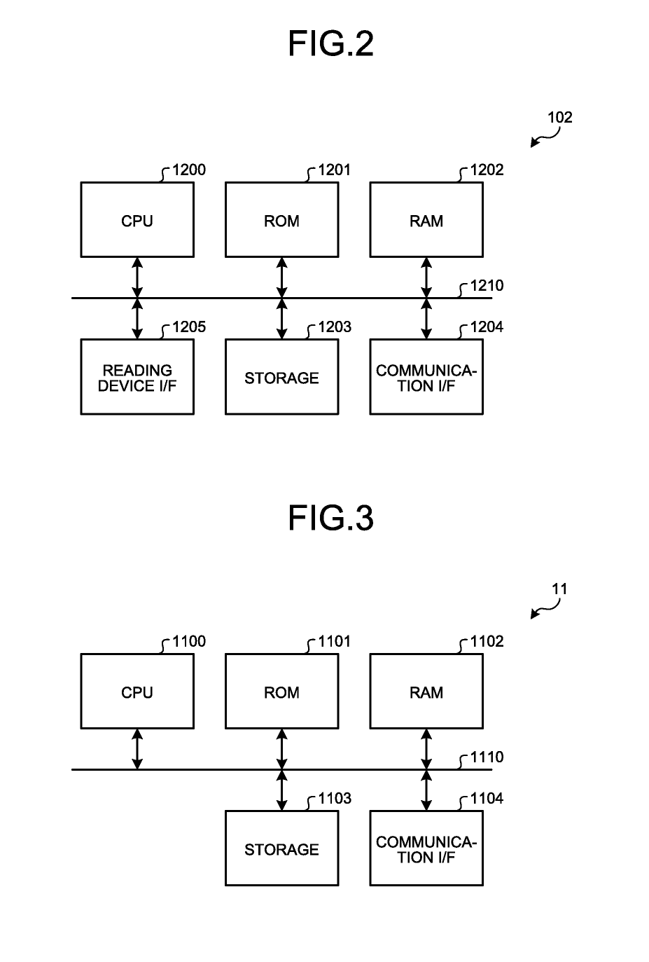

FIG. 2 illustrates an example of the hardware configuration of the authentication device 102 applicable to the first embodiment. The authentication device 102 includes a configuration equivalent to that in a general computer and includes a central processing unit (CPU) 1200, a read only memory (ROM) 1201, a random access memory (RAM) 1202, a storage 1203, a communication I/F 1204, and a reading device I/F 1205. Each of these units is communicably connected to one another with a bus 1210.

The storage 1203 is a non-volatile semiconductor memory such as a hard disk drive and a flash memory and stores therein a computer program operated on the CPU 1200 and various types of data. Furthermore, the ROM 1201 stores therein in advance a computer program and data for starting up the CPU 1200. The computer program operated on the CPU 1200 and various types of data may be stored in the ROM 1201 so that the storage 1203 is omitted.

The CPU 1200 controls the overall operation of the authentication device 102 using the RAM 1202 as a work memory in accordance with computer programs read out from the storage 1203 or the ROM 1201. The communication I/F 1204 controls communication via the network 40 in accordance with an instruction of the CPU 1200. The reading device I/F 1205 is an interface with respect to the reading device 101. For example, a universal serial bus (USB) may be applicable to the reading device I/F 1205.

FIG. 3 illustrates an example of the hardware configuration of the server 11 applicable to the first embodiment. The server 11 is configured by using a general computer and includes a CPU 1100, a ROM 1101, a RAM 1102, a storage 1103, and a communication I/F 1104. Each of these units is communicably connected to one another with a bus 1110.

Operations of the CPU 1100, the ROM 1101, the RAM 1102, the storage 1103, and the communication I/F 1104 described above are substantially the same as those of the CPU 1200, the ROM 1201, the RAM 1202, the storage 1203, and the communication I/F 1204 in the above-described authentication device 102. More specifically, the CPU 1100 uses the RAM 1102 as a work memory to control the overall operation of the server 11 in accordance with computer programs read out from the storage 1103 or ROM 1101. Furthermore, the communication I/F 1104 controls communication via the network 40 in accordance with an instruction of the CPU 1100.

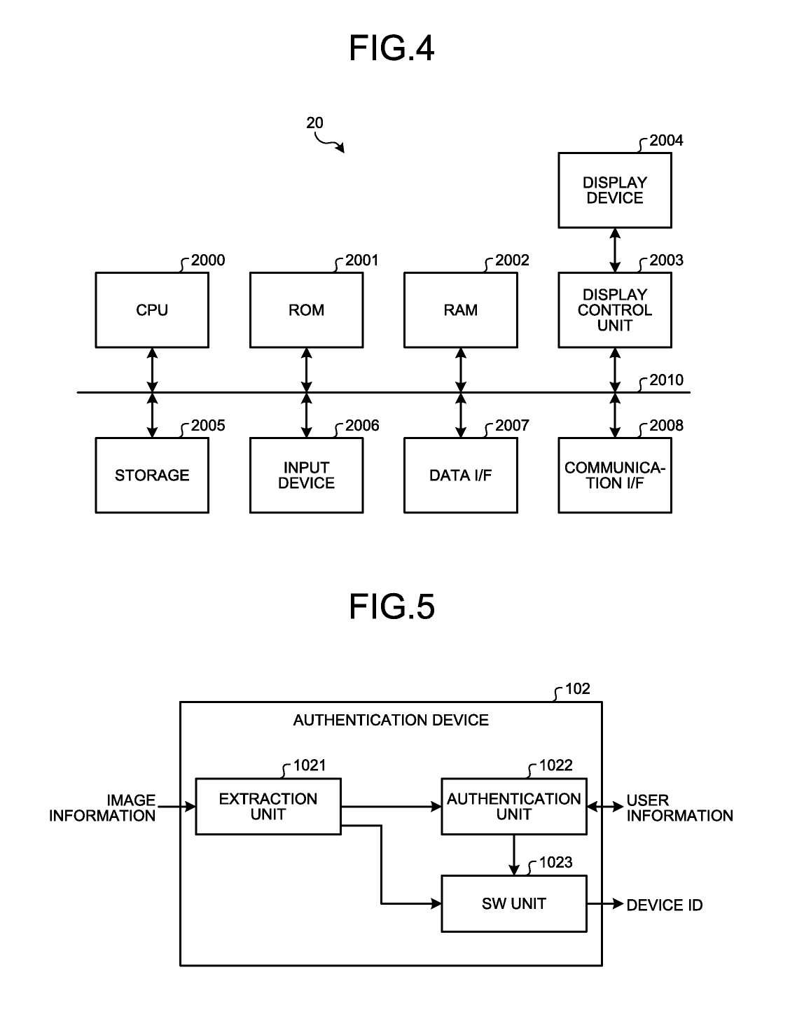

FIG. 4 illustrates an example of the hardware configuration of the terminal device 20 applicable to the first embodiment. The terminal device 20 includes a configuration equivalent to that in a general computer and includes a CPU 2000, a ROM 2001, a RAM 2002, a display control unit 2003, a storage 2005, an input device 2006, a data I/F 2007, and a communication I/F 2008. Each of these units is communicably connected to one another with a bus 2010.

In the configuration illustrated in FIG. 4, operations of these CPU 2000, ROM 2001, RAM 2002, and storage 2005 are substantially the same as those of the CPU 1200, ROM 1201, RAM 1202, and storage 1203 in the above-described authentication device 102. More specifically, the CPU 2000 uses the RAM 2002 as a work memory to control the overall operation of the terminal device 20 in accordance with computer programs read out from the storage 2005 or ROM 2001.

The communication I/F 2008 controls communication via the network 40 in accordance with an instruction of the CPU 2000. The communication I/F 2008 stores, for example, in a register included therein in advance device identification information for identifying the communication I/F 2008. The device identification information is a media access control (MAC) address, for example. By acquiring this device identification information, an external device can start communication with the terminal device 20. In the description below, unless otherwise specified, the device identification information is treated as a device ID for explanation.

The display control unit 2003 generates a signal that can be displayed by a display device 2004 based on a display control signal generated by the CPU 2000 based on a computer program and supplies the generated signal to the display device 2004. The display device 2004 corresponds to a display unit 21 illustrated in FIG. 1 and includes a display element such as a liquid crystal display (LCD) and a drive unit that drives the display unit to perform display in accordance with the signal supplied from the display control unit 2003.

The input device 2006 receives a user operation and outputs a control signal in accordance with the user operation. The input device 2006 and the display device 2004 may be integrally formed and configured as what is called a touch panel. The data I/F 2007 is an interface for performing transmission and reception of data to/from an external device. For example, a USB may be applicable to the data I/F 2007.

FIG. 5 is a functional block diagram explaining an example of a function of the authentication device 102 according to the first embodiment. The authentication device 102 includes an extraction unit 1021, an authentication unit 1022, and a switch (SW) unit 1023. These extraction unit 1021, authentication unit 1022, and SW unit 1023 are implemented by a computer program operated on the CPU 1200. However, the present invention is not limited thereto, and part or all of the extraction unit 1021, the authentication unit 1022, and the SW unit 1023 may be configured as a hardware circuit and operated in cooperation with one another.

The extraction unit 1021 performs processing of analyzing image information supplied with the reading device 101 reading an image for authentication and extracting user information including at least a user ID and a device ID from the image information. The user information and the device ID included in the image for authentication will be described later. The extraction unit 1021 supplies the extracted user information to the authentication unit 1022. Furthermore, the extraction unit 1021 transmits the extracted device ID to the network 40 via the SW unit 1023.

The authentication unit 1022 performs communication with the user DB 13 via the network 40, performs authentication processing by referring to the user DB 13 based on the user information supplied from the extraction unit 1021, and acquires an authentication result indicating success or failure of authentication. Furthermore, the authentication unit 1022 supplies the authentication result to the SW unit 1023. The SW unit 1023 switches whether to output the device ID supplied from the extraction unit 1021 to the network 40 in accordance with the authentication result supplied from the authentication unit 1022.

An authentication program for implementing each function in the authentication device 102 is, for example, stored in a computer connected over the network 40 and downloaded via the network 40 to be supplied to the authentication device 102. However, the present invention is not limited thereto, and the authentication program may be supplied to the authentication device 102 via another network such as the Internet. Furthermore, the authentication program may be recorded as a file of an installable form or an executable form on a computer readable recording medium, such as a compact disc (CD), a flexible disk (FD), or a digital versatile disc (DVD), to be supplied.

The authentication program has a module configuration that includes each of the above-described units (the extraction unit 1021, the authentication unit 1022, and the SW unit 1023). As actual hardware, the CPU 1200 reads out the authentication program from a recording medium such as the storage 1203 and executes the read authentication program, whereby the extraction unit 1021, the authentication unit 1022, and the SW unit 1023 described above are loaded on a main memory device such as the RAM 1202 and thus generated on the main memory device.

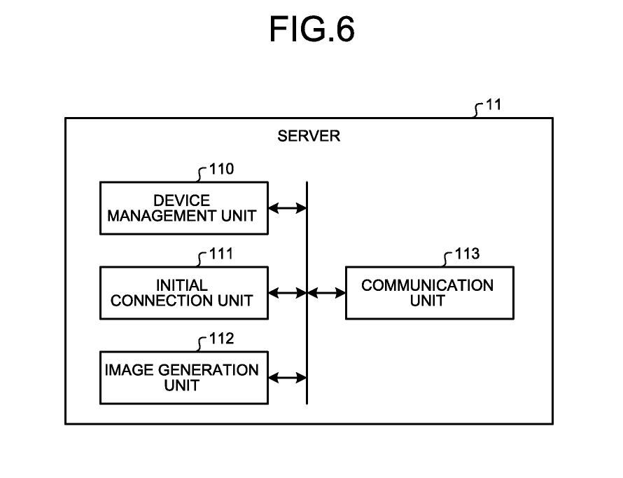

FIG. 6 is a functional block diagram explaining an example of a function of the server 11 according to the first embodiment. The server 11 includes a device management unit 110, an initial connection unit 111, an image generation unit 112, and a communication unit 113. These device management unit 110, initial connection unit 111, image generation unit 112, and communication unit 113 are implemented by a computer program operated on the CPU 1100. However, the present invention is not limited thereto, and part or all of the device management unit 110, the initial connection unit 111, the image generation unit 112, and the communication unit 113 may be configured as a hardware circuit and operated in cooperation with one another.

The communication unit 113 controls communication via the network 40. The device management unit 110 performs management of devices (the MFP 50, the IWB 51, PJs 52 and 53, and the TBLs 54 and 55) connected to the network 40. For example, the device management unit 110 sets a device that can be used by the terminal device 20 connected to the network 40 from outside, out of the devices connected to the network 40, and controls connection to the set device from the terminal device 20. The initial connection unit 111 includes a captive portal function. When an unauthenticated device attempts to access the network 40 via the AP 12, for example, the device is forcibly connected to the initial connection unit 111. The image generation unit 112 generates an image for authentication based on information supplied thereto.

Admission Processing for a User

Next, an example of admission processing for a user that is applicable to the above-described network system will be schematically described. For example, an organization (inviter) causes the user DB 13 to store therein in advance user information of a user who is admitted to a company office building (invitee). The user information stored in the user DB 13 includes at least user identification information for identifying the user (hereinafter, referred to as user ID). The server 11 generates an image for authentication including the user ID for performing authentication in the admission gate device 10 based on the user information stored in the user DB 13 and transmits the generated image to the invitee in a manner attached to an e-mail, for example. As the image for authentication, a two-dimensional code such as a QR code (registered trademark) is applicable.

The invitee receives in advance the e-mail transmitted from the server 11 with the terminal device 20. The invitee causes the image for authentication attached to the e-mail to be displayed on the display unit 21 of the terminal device 20 at the time of admission and puts the display unit 21 on which the image for authentication is displayed over an image reading unit of the reading device 101 of the admission gate device 10. The reading device 101 reads the image for authentication displayed on the display unit 21 of the terminal device 20 and outputs image information based on the read image for authentication to the authentication device 102. In the authentication device 102, the extraction unit 1021 analyzes the image information output from the reading device 101 and extracts the user ID included in the image for authentication from the image information. In the authentication device 102, the authentication unit 1022 refers to the user DB 13 based on the user ID extracted by the extraction unit 1021 to perform authentication processing. When the authentication has been successful, the admission gate device 10, for example, notifies the invitee of the authentication success with a display or by opening a gate, whereby the invitee is admitted to the building.

Authentication and Connection Processing According to the First Embodiment

With a series of pieces of processing for authentication described above, after the admission to the building using the image for authentication, in order to use a device such as the MFP 50 or the IWB 51 connected to the network 40 from the terminal device 20, the invitee needs to perform a separate authentication procedure to cause the terminal device 20 to connect to the network 40. In the first embodiment, one image for authentication is used for the authentication at the time of admission as well as connection processing to the network 40.

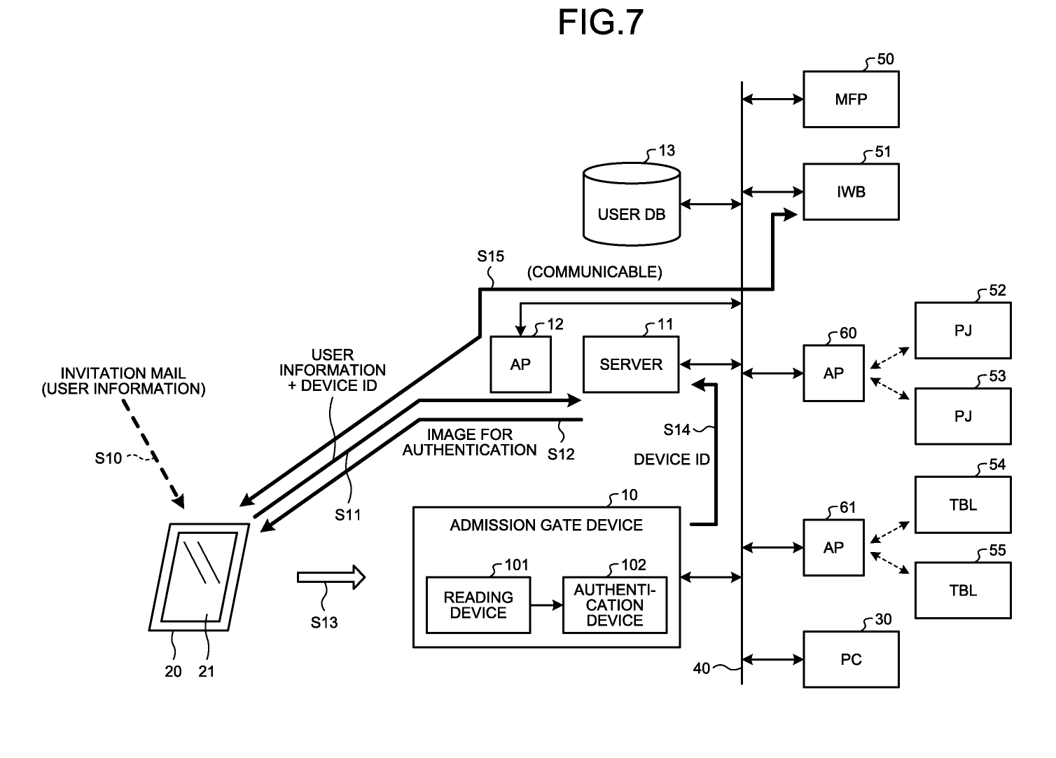

With reference to FIG. 7, procedures of authentication processing and connection control processing according to the first embodiment will be schematically described. It should be noted that in FIG. 7, the common parts to those in FIG. 1 described above are assigned with the same reference numerals, and the detailed explanations thereof are omitted.

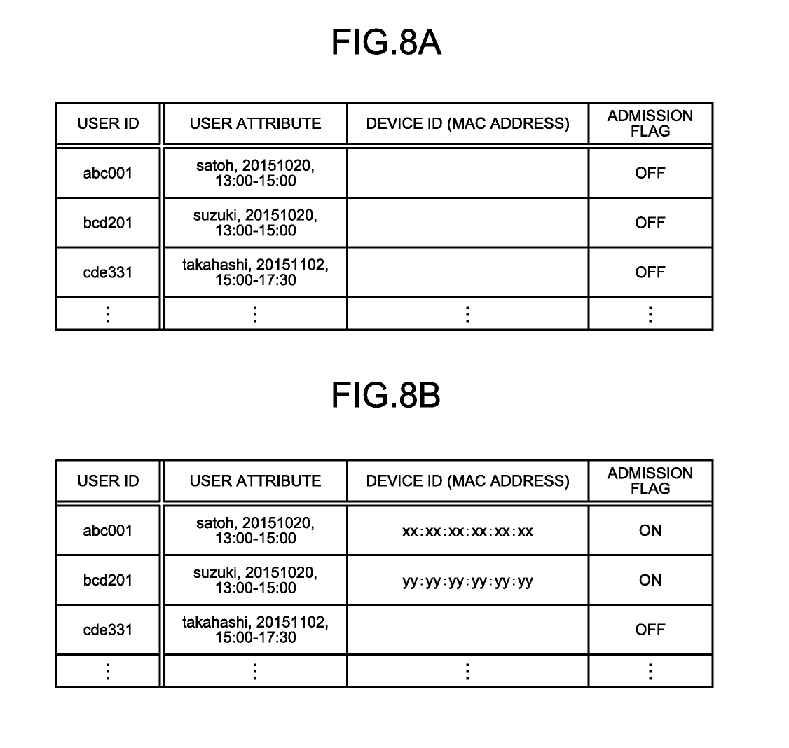

For example, first, in the same manner as described above, an organization being an inviter causes the user DB 13 to store therein in advance user information of a user who is outside the organization and is admitted to the company office building (invitee). FIGS. 8A and 8B each illustrate an example of information stored in the user DB 13 according to the first embodiment. In each of the examples in FIGS. 8A and 8B, the user DB 13 includes items “user ID” and “user attribute”, which are items including user information, an item “device ID”, and an item “admission flag” in each record.

In the item “user ID”, a user ID for identifying a user is stored. In the item “user attribute”, a user attribute indicating an attribute of a user is stored. In the item “device ID”, a device ID for identifying a terminal device 20 is stored. In the item “admission flag”, an admission flag indicating whether a user has been admitted to the company office building is stored.

In these examples, MAC addresses of the terminal devices 20 are applied to the device IDs. A device ID is capable of identifying the terminal device 20 corresponding thereto. Other information is applicable to the device ID when the information can be used for establishing connection to the terminal device 20. If the admission flag has the value “ON”, it is indicated that the user indicated by the user ID has been admitted to the company office building. If the admission flag has the value “OFF”, it is indicated that the user indicated by the user ID is absent in (has left from) the company office building. Furthermore, in the user DB 13, with respect to a user ID, an e-mail address of the user indicated by the user ID is preferably further stored in an associated manner.

Initially, as illustrated in FIG. 8A, in the user DB 13, user IDs are stored in the item “user ID” and user attributes are stored in the item “user attribute”. The item “device ID” is left blank. Furthermore, in the item “admission flag”, the value “OFF” is stored. For a user ID, for example, a value unique to the user is generated by the system to be stored in the user DB 13. In a user attribute, in the example in FIG. 8A, a user name indicated by a user ID and an expected date of admission are included. The user attribute is not limited to this example, and other information related to the user indicated by the user ID may be applicable. Furthermore, the user attribute can be omitted.

In FIG. 7, the inviter refers to the user DB 13 and transmits a message that describes user information (first identification information) including at least the user ID of a user who is admitted to the company office building (invitee) and a predetermined uniform resource locator (URL) to the invitee using an e-mail (referred to as an invitation mail), for example (Step S10). The invitation mail may be transmitted from the server 11 or transmitted from the PC 30. The present invention is not limited thereto, and the invitation mail may be transmitted from other PC that is not directly connected to the network 40.

For the URL described in the invitation mail (initial URL), an optional one may be used. For example, the URL of the server 11 can be used. The user information can be described in the message in manner added to the initial URL as an argument, for example. This invitation mail is received by the invitee, for example, using the terminal device 20 and stored in the storage 2005 included in the terminal device 20.

The invitee, for example, goes to the company office building of the inviter bringing the terminal device 20 of which the storage 2005 stores therein the invitation mail from the inviter and operates the terminal device 20 to communicate based on Wi-Fi with the AP 12 using the SSID described in the invitation mail and transmit a connection request to the initial URL to the AP 12 from the terminal device 20. It should be noted that the communication from the terminal device 20 is performed in the unit of packets of a predetermined size, and each packet includes a MAC address as the device ID of the terminal device 20.

This connection request is forcibly guided to the initial connection unit 111 due to the captive portal function in the initial connection unit 111 of the server 11. The server 11, using the initial connection unit 111, acquires the user information added to the initial URL included in the connection request and the device ID (second identification information) of the terminal device 20 stored in the packet used for the transmission of the connection request (Step S11). In this example, as described above, as the device ID, the MAC address of the terminal device 20 is used.

The server 11 forwards the user information and the device ID acquired using the initial connection unit 111 to the image generation unit 112. The image generation unit 112, based on the user information and the device ID received from the initial connection unit 111, generates an image for authentication including the user information and the device ID. In this example, as the image for authentication, a QR code (registered trademark) being a two-dimensional code is used. The image for authentication is not limited to a two-dimensional code, and other types of image may be used as long as the user information and the device ID can be extracted by reading the image. For example, a bar code being a one-dimension code may be used as the image for authentication, and the character strings of the user information and the device ID themselves may be imaged.

The image generation unit 112 transmits the generated image for authentication to the terminal device 20 (Step S12). When the image for authentication is received by the terminal device 20, the invitee causes the display unit 21 to display the received image for authentication and puts the received image over the reading unit of the reading device 101 of the admission gate device 10 (Step S13). The reading device 101 reads the image for authentication displayed on the display unit 21 of the terminal device 20 and outputs image information based on the image for authentication to the authentication device 102.

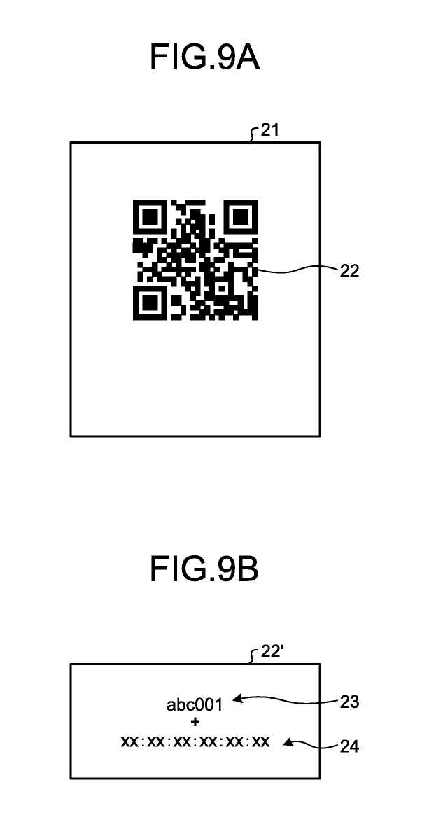

FIGS. 9A and 9B each illustrate an example of an image for authentication that is displayed on a display unit 21 of the terminal device 20 according to the first embodiment. As illustrated in FIG. 9A, an image for authentication 22 is displayed on the display unit 21. For the image for authentication 22, as described above, a QR code (registered trademark) being a two-dimensional code is used. This image for authentication 22 is, as illustrated in FIG. 9B, obtained by coding the information for authentication 22′ including the user ID 23 and the device ID 24 into a two-dimensional code to visualize the information for authentication 22′.

The authentication device 102 uses the extraction unit 1021 to analyze the image information supplied from the reading device 101 to extract the user information and the device ID and uses the authentication unit 1022 to refer to the user DB 13 based on the extracted user information to perform authentication processing. The authentication unit 1022 uses the user ID included in the user information to perform authentication processing, for example. The present invention is not limited thereto, and the authentication unit 1022 may perform authentication processing based on the user ID and the user attribute included in the user information. Furthermore, in this case, out of pieces of information included in the user attribute, a specified piece of information may be used for authentication processing.

When the authentication has been successful, the authentication device 102 uses the authentication unit 1022 to close the SW unit 1023 and causes the device ID extracted by the extraction unit 1021 to be output from the authentication device 102 via the SW unit 1023 and transferred to the server 11 (Step S14).

Furthermore, the authentication device 102 cause the device ID to be stored in a record to which the user information corresponds in the user DB 13. In contrast with the above-described FIG. 8A, FIG. 8B illustrates an example in which the device ID has been added to be stored. In the example in FIG. 8B, authentication for the users of which the values of the item “user ID” are “abc001” and “bcd201” has been successful, and to each of the records of the user IDs “abc001” and “bcd201”, a device ID is added to be stored. For the value in the item “admission flag”, as described above, in accordance with the authentication result from the authentication device 102, either of the values “ON” or “OFF” is stored.

In the example FIG. 8B, authentication for the user IDs “abc001” and “bcd201” has been successful, and in the item “device ID” of each of the records corresponding thereto, a value is stored. At the same time, values in the item “admission flag” are set to “ON”. By contrast, in this example, a user having the user ID “cde331” has not received authentication by the admission gate device 10, and the item “device ID” is left blank and the value in the item “admission flag” is set to “OFF”.

Furthermore, when the authentication has been successful, the authentication unit 1022 refers to the user DB 13 based on the user information and checks the value of the admission flag corresponding to the user information. When the value of the admission flag stored in the user DB 13 corresponding to the user information is “OFF”, the authentication unit 1022 overwrites the value of this admission flag with “ON”. Furthermore, when the value of the admission flag stored in the user DB 13 corresponding to the user information is “ON”, the authentication unit 1022 overwrites the value of this admission flag with “OFF”. More specifically, when the authentication has been successful and the invitee (the terminal device 20) is in the admitted state, the invitee performs authentication processing based on the image for authentication again, whereby the state is changed to the left state. With this, the admitted state and the left state of the invitee can be managed.

The server 11 forwards the device ID to the device management unit 110. The device management unit 110 establishes connection with the terminal device 20 based on the device ID (Step S15). With this, the terminal device 20 performs communication with the network 40 via the server 11, whereby each device (in the example in FIG. 1, the MFP 50, the IWB 51, the PJs 52 and 53, and the TBLs 54 and 55) which is connected to the network 40 becomes usable.

At this time, the server 11 uses the device management unit 110 to manage whether the terminal device 20 identified by the device ID can access to each device connected to the network 40. For example, the server 11 uses the device management unit 110 to overwrite a destination of communication from the terminal device 20 with a predetermined address. With this, devices accessible from the terminal device 20 can be limited to set devices out of the devices connected to the network 40.

As described above, in the first embodiment, the invitee transmits the user information received in advance to the network system and acquires the image for authentication including the device ID and the user information from the network system. The invitee then uses the acquired image for authentication to perform authentication processing related to admission in the admission gate device 10 and connection processing to the network 40. With this, the invitee can use the terminal device 20 connected to the network 40 without consciously performing authentication processing for the terminal device 20. Furthermore, at the inviter side, there is no need to manually perform authentication of the invitee and the terminal device 20.

In FIGS. 1 and 6, the image generation unit 112 is provided in the server 11 connected to the network 40. However, the present invention is not limited these examples. For example, the image generation unit 112 may be provided on other network connectable to the network 40, such as the Internet.

Furthermore, in FIG. 1, the reading device 101 and the authentication device 102 are provided in the admission gate device 10. However, the present invention is not limited this example. For example, in the admission gate device 10, only the reading device 101 may be provided, and the authentication device 102 may be provided outside the admission gate device 10. Furthermore, in this case, the authentication device 102 can be provided in the server 11.

Furthermore, in the explanation above, the first embodiment is applied to admission processing using the admission gate device 10. However, the present invention is not limited thereto. More specifically, in the first embodiment, the terminal device 20 performing authentication of the invitee and used by the invitee can be applied to other systems as long as the terminal device 20 is connected to the network 40 closed inside an organization.

### More Detailed Description of the First Embodiment

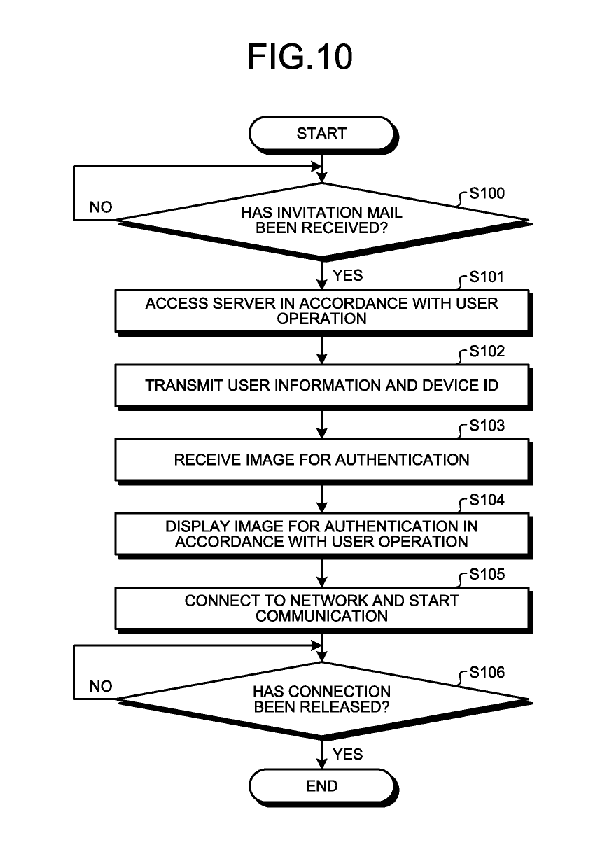

FIG. 10 is a flowchart illustrating an example of processing performed in the terminal device 20 according to the first embodiment. At Step S100, the terminal device 20 determines whether an invitation mail has been received that includes a message describing the user information, the initial URL, and the SSID of the AP12. When the terminal device 20 determines that the invitation mail has not been received (“No” at Step S100), the terminal device 20 returns the processing to Step S100. By contrast, when the terminal device 20 determines that the invitation mail has been received (“Yes” at Step S100), the terminal device 20 shifts the processing to Step S101.

At Step S101, the invitee is assumed to be near the admission gate device 10 holding the terminal device 20 of which the storage 2005, for example, stores therein the invitation mail.

At Step S101, the terminal device 20 attempts to access the initial URL described in the message included in the invitation mail in accordance with the user operation. For example, when the invitee operates the terminal device 20 and instructs transmission of a connection request to the initial URL, the terminal device 20 starts processing of establishing communication with the AP 12. When the terminal device 20 is requested for an input of the SSID by the AP 12, the terminal device 20 causes the display unit 21 to display the request. The invitee operates the terminal device 20 to input the SSID of the AP 12 described in the invitation mail and transmits the input SSID to the AP 12. With this, communication between the terminal device 20 and the AP 12 is established.

When communication between the terminal device 20 and the AP 12 is established, due to the captive portal function of the server 11, the communication destination of the terminal device 20 is guided to the initial connection unit 111, so that communication between the terminal device 20 and the initial connection unit 111 is forcibly started. With this communication, the terminal device 20 transmits the user information and the device ID to the server 11 (Step S102). The server 11 generates the image for authentication 22 based on the user information and the device ID transmitted from the terminal device 20 and transmits the generated image for authentication 22 to the terminal device 20. The terminal device 20 receives the image for authentication 22 transmitted from the server 11 (Step S103).

At subsequent Step S104, the terminal device 20 causes the display unit 21 to display the image for authentication 22 received at Step S103 in accordance with the user operation. The invitee puts the display unit 21 of the terminal device 20 on which the image for authentication 22 is displayed over the image reading unit of the reading device 101 of the admission gate device 10.

At the admission gate device 10, the authentication device 102 performs authentication processing based on the user information included in the image for authentication as described at Step S14 in FIG. 7. When the authentication has been successful, the device ID is stored in the user DB 13, and at the same time, transferred to the server 11. The server 11 establishes connection with the terminal device 20 based on the device ID. With this, the terminal device 20 is connected to the network 40 via the server 11 so as to start communication via the network 40 (Step S105).

At subsequent Step S106, the terminal device 20 determines whether connection with the network 40 has been released. When the terminal device 20 determines that the connection with the network 40 has not been released (“No” at Step S106), the terminal device 20 returns the processing to Step S106 to continue the communication. By contrast, when the terminal device 20 determines that the connection with the network 40 has been released (“Yes” at Step S106), the terminal device 20 ends a series of pieces of processing shown in FIG. 10.

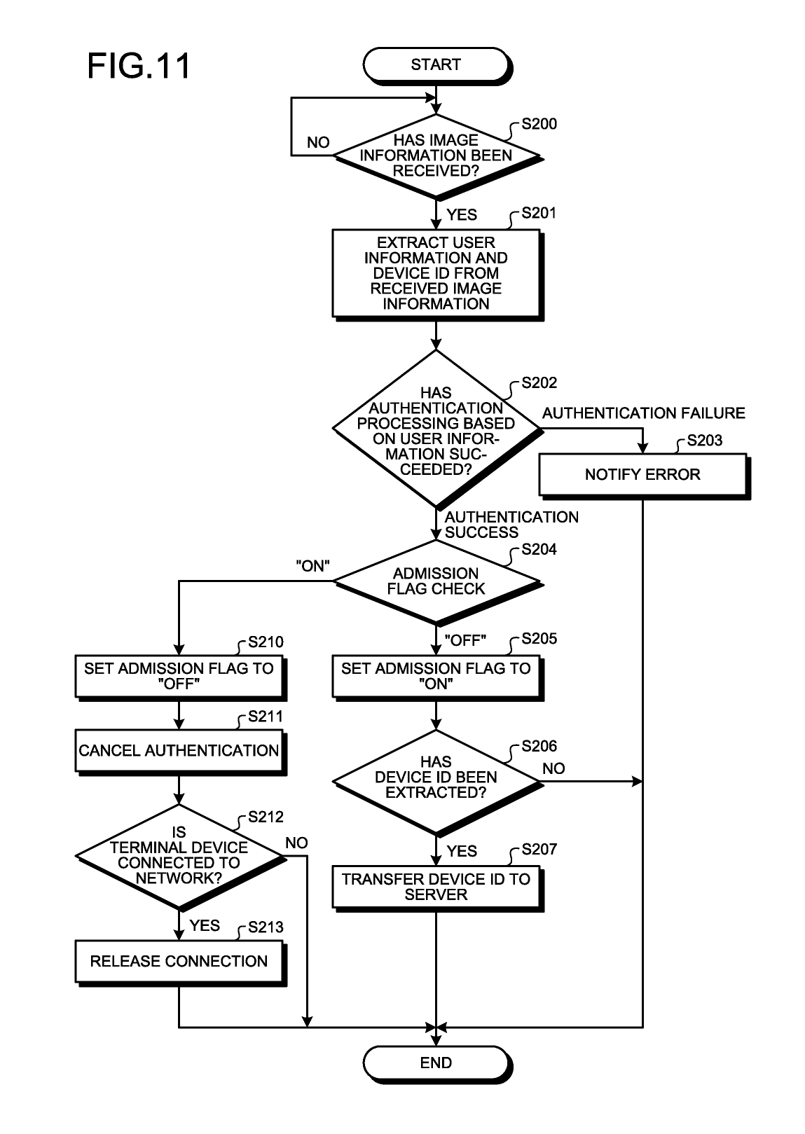

FIG. 11 is a flowchart illustrating an example of authentication processing performed in the authentication device 102 according to the first embodiment. At Step S200, the extraction unit 1021 determines whether image information has been received from the reading device 101. When the extraction unit 1021 determines that image information has not been received (“No” at Step S200), the extraction unit 1021 returns the processing to Step S200. By contrast, when the extraction unit 1021 determines that image information has been received (“Yes” at Step S200), the extraction unit 1021 shifts the processing to Step S201.

At Step S201, the extraction unit 1021 analyzes the image information received from the reading device 101 to extract the user information and the device ID. At subsequent Step S202, the authentication unit 1022, based on the user information extracted by the extraction unit 1021, refers to the user DB 13 to perform authentication processing. For example, when a use ID identical with the user ID included in the user information extracted by the extraction unit 1021 is stored in the user DB 13, the authentication unit 1022 determines that the authentication has been successful.

When the authentication has failed at Step S202 (“authentication failure” at Step S202), the authentication unit 1022 shifts the processing to Step S203 to perform error notification. The error notification may be performed by display on or operations in the admission gate device 10. Alternatively, the error may be notified to the PC 30 via the network 40 and displayed on a display unit of the PC 30. When the error notification is performed at Step S203, a series of pieces of processing in the flowchart in FIG. 11 is ended.

By contrast, when the authentication has been successful at Step S202 (“authentication success” at Step S202), the authentication unit 1022 shifts the processing to Step S204. At Step S204, the authentication unit 1022 refers to the user DB 13 based on the user information and checks the admission flag corresponding to the user information.

When the authentication unit 1022 determines the value of the item “admission flag” corresponding to the user information is “OFF” (“OFF” at Step S204), the authentication unit 1022 shifts the processing to Step S205. At Step S205, the authentication unit 1022 overwrites the value of the “admission flag” corresponding to the user information with “ON” in the user DB 13 and moves the processing to Step S206.

At Step S206, the authentication unit 1022 determines whether the device ID has been extracted from the image information by the extraction unit 1021 at the above-described Step S201. When the authentication unit 1022 determines that the device ID has not been extracted from the image information (“No”, at Step S206), the authentication unit 1022 ends the pieces of processing in the flowchart in FIG. 11. In this case, for the invitee corresponding to the user information, only admission is permitted, and connection from the terminal device 20 to the network 40 is not permitted.

By contrast, when the authentication unit 1022 determines at Step S206 that the device ID has been extracted (“Yes” at Step S206″), the authentication unit 1022 moves the processing to Step S207. At Step S207, the authentication unit 1022 controls the SW unit 1023 to be in the closed state and transfers the device ID extracted by the extraction unit 1021 to the server 11 via the SW unit 1023. Furthermore, the authentication unit 1022 causes the device ID to be stored in the user DB 13 based on the corresponding user information. The server 11, as described at Step S15 in FIG. 7, establishes connection with the terminal device 20 based on the device ID. With this, the terminal device 20 can communicate with the network 40 via the server 11.

At Step S204 described above, when the authentication unit 1022 determines that the value of the item “admission flag” corresponding to the user information is “ON”, (“ON” at Step S204), the authentication unit 1022 moves the processing to Step S210. After that, the processing at Step S210 to Step S213 will be the processing for leaving.

At Step S210, the authentication unit 1022 overwrites the value of the item “admission flag” corresponding to the user information with “OFF” in the user DB 13 and shifts the processing to subsequent Step S211. At Step S211, the authentication unit 1022 cancels authentication for the invitee corresponding to the user information and shifts the processing to Step S212.

At Step S212, the authentication unit 1022 determines whether the terminal device 20 corresponding to the user information is connected to the network 40. For example, the authentication unit 1022, based on the device ID corresponding to the user information extracted by the extraction unit 1021, makes an inquiry to the device management unit 110 of the server 11 whether the device having the device ID is currently connected to the network 40. When the authentication unit 1022 determines that the terminal device 20 is not connected to the network 40 (“No” at Step S212), the authentication unit 1022 ends the pieces of processing in the flowchart shown in FIG. 11.

By contrast, when the authentication unit 1022 determines that the terminal device 20 is connected to the network 40 (“Yes” at Step S212), the authentication unit 1022 shifts the processing to Step S213. At Step S213, the authentication unit 1022 releases connection from the terminal device 20 to the network 40. For example, the authentication unit 1022 requests the device management unit 110 of the server 11 to release connection from the device having the device ID corresponding to the user information extracted by the extraction unit 1021 to the network 40 and ends the pieces of processing in the flowchart shown in FIG. 11. In response to this request, the device management unit 110 releases connection from the device (terminal device 20) to the network 40.

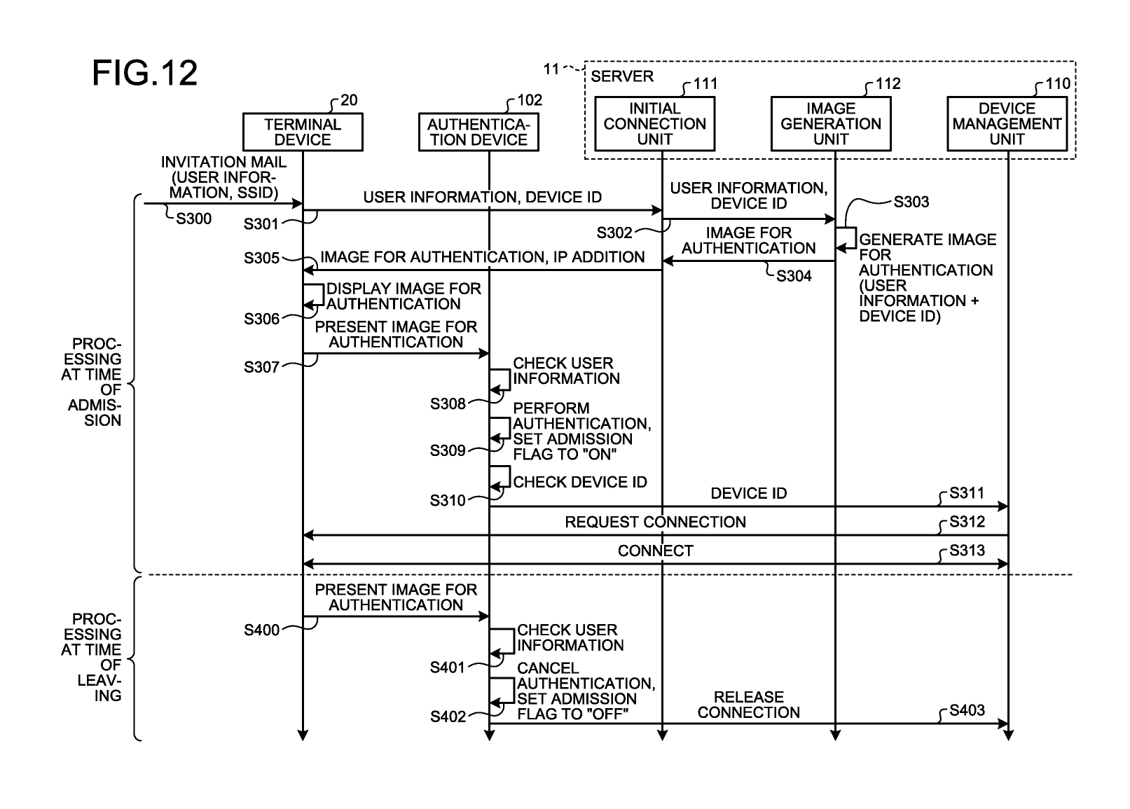

FIG. 12 is a sequence diagram illustrating an example of more detailed procedures of the authentication processing and the connection control processing according to the first embodiment. It should be noted that in FIG. 12, the common parts to those in FIGS. 6 and 7 described above are assigned with the same reference numerals, and the detailed explanations thereof are omitted.

First, processing at the time of admission will be described with Step S300 to Step S313. At Step S300, an invitation mail that is transmitted from the inviter to the invitee and includes a message describing user information, SSID, and a predetermined URL is, for example, received by the terminal device 20 used by the invitee. The invitee, for example, goes to the company office building of the inviter bringing the terminal device 20 having received the invitation mail and operates the terminal device 20 to communicate with the AP 12 using the SSID described in the invitation mail and transmit a connection request to the initial URL to the AP 12 from the terminal device 20 (Step S301). The connection request includes the predetermined URL described in the message included in the invitation mail and the user information. This connection request is forcibly guided to the initial connection unit 111 due to the captive portal function in the initial connection unit 111 of the server 11.

The initial connection unit 111 receives the connection request, acquires the user information and the device ID (MAC address) of the terminal device 20 from the received connection request, and forwards the acquired user information and the device ID to the image generation unit 112 (Step S302). The image generation unit 112, based on the user information and the device ID received from the initial connection unit 111, generates an image for authentication by coding the user information and the device ID into an image (Step S303). The image generation unit 112 forwards the generated image for authentication to the initial connection unit 111 (Step S304).

The initial connection unit 111 performs communication with the terminal device 20 based on the device ID of the terminal device 20 and transmits the image for authentication received from the image generation unit 112 to the terminal device 20. At the same time, the initial connection unit 111 adds an Internet protocol (IP) address to the terminal device 20 (Step S305). The terminal device 20 receives the image for authentication transmitted from the initial connection unit 111 and causes, for example, the storage 2005 to store therein the received image for authentication.

The terminal device 20 causes the display unit 21 to display the image for authentication received from the initial connection unit 111 in accordance with an operation of the invitee, for example (Step S306). The invitee puts the display unit 21 of the terminal device 20 over the image reading unit of the reading device 101 of the admission gate device 10 to present the image for authentication (Step S307). The reading device 101 reads the image for authentication displayed on the display unit 21 to output image information.

The authentication device 102 analyzes the image information output from the reading device 101 and extracts the user information and the device ID from the image information. The authentication device 102 checks whether the user information has been extracted from the image information (Step S308). When the authentication device 102 determines that the user information has been extracted, the authentication device 102 refers to the user DB 13 to perform authentication of the user information. When the authentication of the user information has been successful, the authentication device 102 checks the value of the admission flag corresponding to the user information in the user DB 13. When the value of the admission flag is “OFF”, the authentication device 102 overwrites the value with “ON” (Step S309). Furthermore, the authentication device 102 checks whether the device ID has been extracted from the image information (Step S310).

When the authentication device 102 determines that the device ID has been extracted from the image information, the authentication device 102 transfers this device ID to the server 11. The transferred device ID is received by the device management unit 110 in the server 11 (Step S311). The device management unit 110 transmits a connection request to the terminal device 20 based on the device ID (Step S312) and performs connection establishment processing with the terminal device 20. When connection is established, the terminal device 20 is enabled to communicate with the network 40 via the server 11 (Step S313).

Next, processing at the time of leaving will be described with Step S400 to Step S403. At the time of leaving, the invitee operates the terminal device 20 to cause the display unit 21 to display the image for authentication presented at the time of admission and presents the image for authentication by putting the image over the reading unit of the reading device 101 of the admission gate device 10 (Step S400). The reading device 101 outputs the image for authentication displayed on the display unit 21 to output the image information.

The authentication device 102 analyzes the image information output from the reading device 101 and extracts the user information and the device ID from the image information. The authentication device 102 checks whether the user information has been extracted from the image information (Step S401). When the authentication device 102 determines that the user information has been extracted from the image information, the authentication device 102 refers to the user DB 13 to perform authentication of the user information. When the authentication of the user information has been successful, the authentication device 102 checks whether the value of the admission flag corresponding to the user information is “ON” in the user DB 13. When the value is “ON”, the authentication device 102 overwrites the value with “OFF” and further cancels authentication for the user information (Step S402). The authentication device 102 then requests the device management unit 110 to release connection from the terminal device 20 having the device ID corresponding to the user information to the network 40 (Step S403).

### Second Embodiment

Next, a second embodiment will be described. In the first embodiment described above, the image for authentication has been generated at the network system side. By contrast, in the second embodiment, the image for authentication is generated in the terminal device 20.

In the second embodiment, the network system described with reference to FIG. 1 is applicable without any change. The detailed descriptions of the network system thus will be omitted. Furthermore, the hardware configurations of the authentication device 102, the server 11, and the terminal device 20 described with reference to FIGS. 2, 3, and 4 and the function of the authentication device 102 described with reference to FIG. 5 are applicable to the second embodiment without any change. The detailed descriptions of these thus will be omitted. It should be noted that in the second embodiment, to the server 11 described with reference to FIG. 6, a configuration in which the initial connection unit 111 and the image generation unit 112 are omitted is applied.

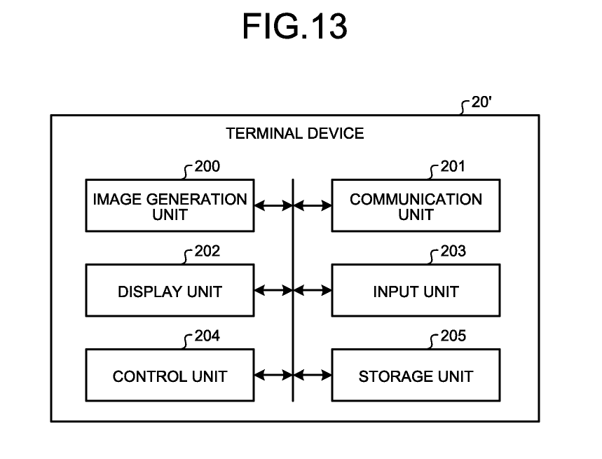

FIG. 13 is a functional block diagram explaining an example of a function of a terminal device according to a second embodiment of the present invention. In FIG. 13, the terminal device 20′ includes an image generation unit 200, a communication unit 201, a display unit 202, an input unit 203, a control unit 204, and a storage unit 205. The image generation unit 200, the communication unit 201, the display unit 202, the input unit 203, the control unit 204, and the storage unit 205 described above are implemented by a computer program operated on the CPU 2000 (refer to FIG. 4). The present invention is not limited thereto, and part or all of these units excluding the image generation unit 200, that is, the communication unit 201, the display unit 202, the input unit 203, the control unit 204, and the storage unit 205 may be configured as a hardware circuit and operated in cooperation with one another.

The image generation unit 200 generates an image obtained by coding information that has been input and performs visualization of the information. In this example, the image generation unit 200, similarly to the image generation unit 112 included in a server 11 in the first embodiment described above, codes the information into a QR code (registered trademark) being a two-dimensional code.

The communication unit 201 controls communication compliant with Wi-Fi using the communication I/F 2008 (refer to FIG. 4). The display unit 202 controls display on the display device 2004 (refer to FIG. 4). The input unit 203 receives a user operation performed on the input device 2006 (refer to FIG. 4). The control unit 204 controls the overall operation of the terminal device 20′. The storage unit 205 controls reading and writing of data performed on the RAM 2002 and the storage 2005 (refer to FIG. 4).

A computer program for implementing each function in the terminal device 20′ is supplied to the terminal device 20′ via other network such as the Internet, for example. The present invention is not limited thereto, and the computer program may be recorded as a file of an installable form or an executable form on a non-transitory computer-readable recording medium, such as a compact disc (CD), a flexible disk (FD), or a digital versatile disc (DVD), to be supplied. Furthermore, the computer program may be stored in a computer connected over the network 40 and downloaded via the network 40 to be supplied to the terminal device 20′.

The computer program has a module configuration that includes each of the above-described units (the image generation unit 200, the communication unit 201, the display unit 202, the input unit 203, the control unit 204, and the storage unit 205). As actual hardware, the CPU 2000 reads out the computer program from a recording medium such as the storage 2005 and executes the read computer program, whereby the image generation unit 200, the communication unit 201, the display unit 202, the input unit 203, the control unit 204, and the storage unit 205 described above are loaded on a main memory device such as the RAM 2002 and thus generated on the main memory device.

The computer program may include only the image generation unit 200. In this case, the computer program implements the functions of the units other than the image generation unit 200 (the communication unit 201, the display unit 202, the input unit 203, the control unit 204, and the storage unit 205) with an operating system (OS) mounted on the terminal device 20′.

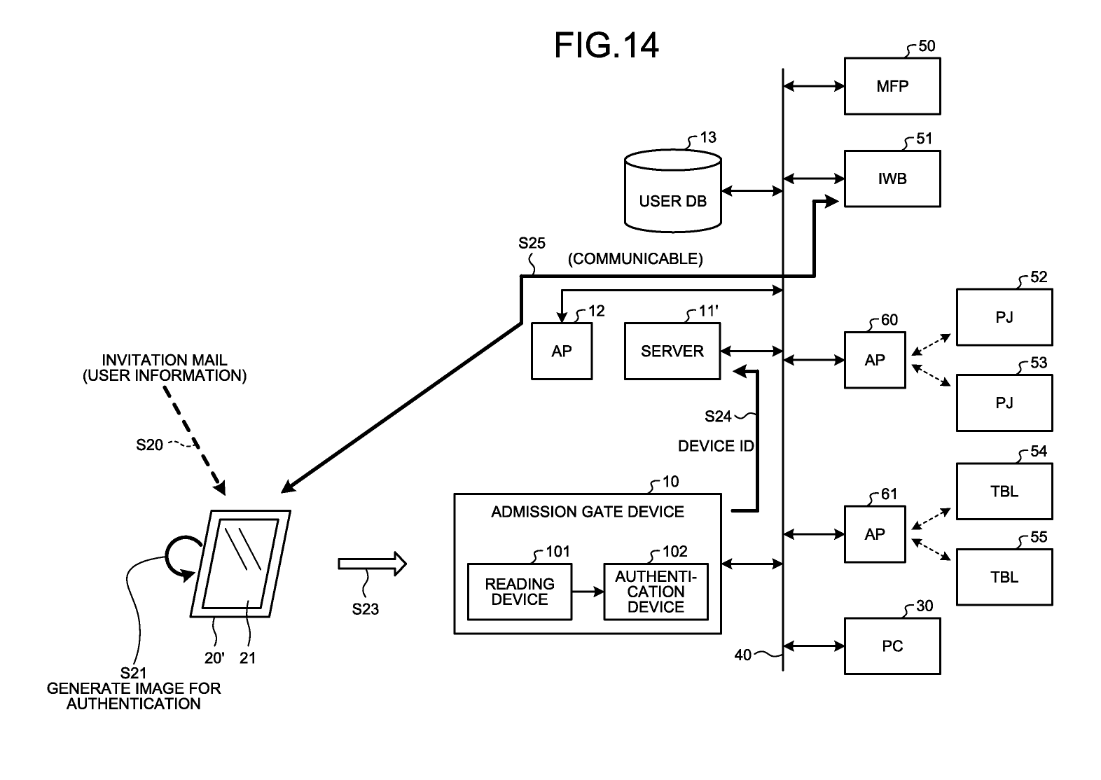

With reference to FIG. 14, procedures of authentication processing and connection control processing according to the second embodiment will be schematically described. It should be noted that in FIG. 14, the common parts to those in FIG. 1 described above are assigned with the same reference numerals, and the detailed explanations thereof are omitted. Furthermore, in FIG. 14, the server 11′ corresponds to the server 11 in FIG. 1 and has a configuration in which the initial connection unit 111 and the image generation unit 112 are omitted in comparison with the server 11 according to the first embodiment.

In FIG. 14, the invitee, similarly in the first embodiment, for example, refers to the user DB 13 and transmits to the invitee an invitation mail that includes a message describing user information including at least a user ID of the invitee (Step S20). This message may further describe the SSID of the AP 12. The invitation mail is received by the invitee, for example, using the terminal device 20′ and stored in the storage 2005 included in the terminal device 20′.

The terminal device 20′ uses the image generation unit 200 to generate, based on the user information described in the message included in the invitation mail and the device ID (MAC address) thereof, an image for authentication including the user information and the device ID, in accordance with a user operation, for example (Step S21). The terminal device 20′ uses the storage unit 205 to cause, for example, the storage 2005 to store therein the image for authentication generated by the image generation unit 200.

The invitee goes to the company office building bringing the terminal device 20′ of which the storage 2005 stores therein the image for authentication. The terminal device 20′, for example, in accordance with a user operation, reads out the image for authentication from the storage 2005, and causes the display unit 21 to display the image for authentication. The invitee puts the image for authentication over the reading unit of the reading device 101 of the admission gate device 10 (Step S23). The reading device 101 reads out the image for authentication displayed on the display unit 21 of the terminal device 20′ and outputs image information based on the image for authentication to the authentication device 102.

The authentication device 102 analyzes the image information supplied from the reading device 101 to extract the user information and the device ID and refers to the user DB 13 based on the extracted user information to perform authentication processing. When the authentication has been successful, the authentication device 102 causes the authentication device 102 to output the device ID extracted by the extraction unit 1021 and transfers the output device ID to the server 11′ (Step S24). Furthermore, the authentication device 102 refers to the user DB 13 and causes the device ID to be stored in the record corresponding to the user information.

The server 11′ forwards the device ID transmitted from the authentication device 102 to the device management unit 110. The device management unit 110 establishes connection with the terminal device 20′ based on the device ID (Step S25). With this, the terminal device 20′ is enabled to perform communication with the network 40 via the server 11′, and out of the devices connected to the network 40, a set device becomes usable.

### More Detailed Description of the Second Embodiment

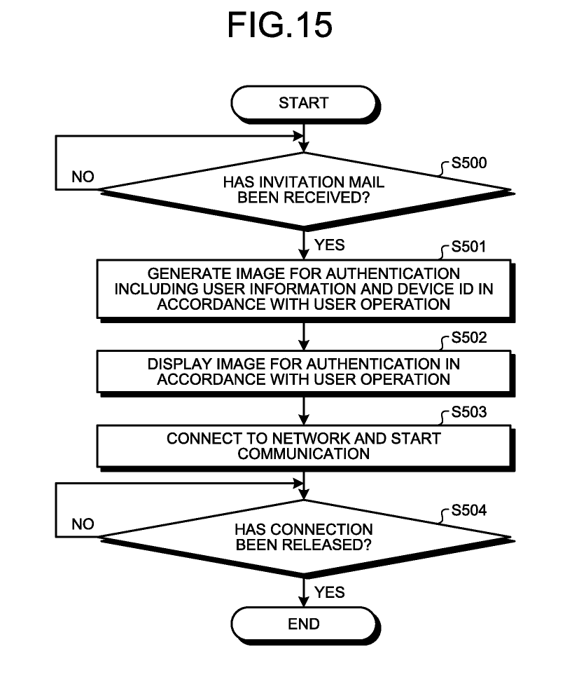

FIG. 15 is a flowchart illustrating an example of processing performed in the terminal device 20′ according to the second embodiment. At Step S500, the terminal device 20′ determines whether the invitation mail that includes the message describing the user information has been received. When the terminal device 20′ determines that the invitation mail has not been received (“No” at Step S500), the terminal device 20′ returns the processing to Step S200. By contrast, the terminal device 20′ determines that the invitation mail has been received (“Yes” at Step S500), the terminal device 20′ shifts the processing to Step S501.

At Step S501, the terminal device 20′, based on the user information described in the message included in the invitation mail and the device ID thereof, uses the image generation unit 200 to generate an image for authentication including the user information and the device ID, in accordance with a user operation, for example.

At subsequent Step S502, the terminal device 20′ causes the display unit 21 to display the image for authentication generated at Step S501, in accordance with a user operation, for example. The invitee puts the display unit 21 of the terminal device 20′ on which the image for authentication is displayed over the image reading unit of the reading device 101 of the admission gate device 10.

In the admission gate device 10, the authentication device 102, as described at Step S24 in FIG. 14, performs authentication processing based on the user information included in the image for authentication. When the authentication has been successful, the authentication device 102 causes the device ID to be stored in the user DB 13 as well as transferred to the server 11′. The server 11′ establishes connection with the terminal device 20′ based on the device ID. With this, the terminal device 20′ is connected to the network 40 via the server 11′ and communication performed by the terminal device 20′ is started via the network 40 (Step S503).

At subsequent Step S504, the terminal device 20′ determines whether connection with the network 40 has been released. When the terminal device 20′ determines that the connection with the network 40 has not been released (“No” at Step S504), the terminal device 20′ returns the processing to Step S504 to continue the communication. By contrast, when the terminal device 20′ determines that the connection with the network 40 has been released (“Yes” at Step S504), the terminal device 20′ ends a series of pieces of processing in FIG. 15.

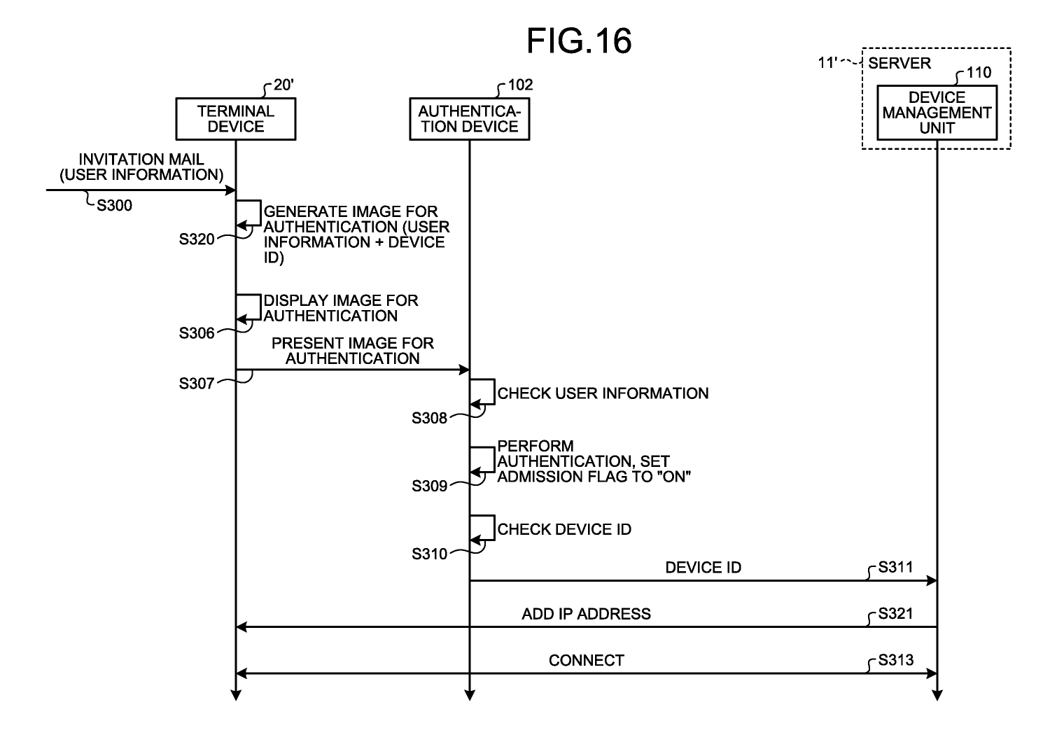

FIG. 16 is a sequence diagram illustrating an example of more detailed procedures of the authentication processing and the connection control processing according to the second embodiment. It should be noted that in FIG. 16, the common parts to those in FIGS. 6 and 7 described above and the sequence diagram in FIG. 12 are assigned with the same reference numerals, and the detailed explanations thereof are omitted.

In the processing at the time of admission, at Step S300, an invitation mail that is transmitted from the inviter to the invitee and includes a message describing user information is, for example, received by the terminal device 20′ used by the invitee (Step S300). The terminal device 20′, based on the user information described in the message included in the invitation mail and the device ID thereof, generates an image for authentication including the user information and the device ID, in accordance with a user operation, for example (Step S320).

The invitee, for example, goes to the company office building of the inviter bringing the terminal device 20′ with which the invitation mail has been received and operates the terminal device 20′ to cause the display unit 21 of the terminal device 20′ to display the image for authentication generated at Step S320 (Step S306). The invitee puts the display unit 21 of the terminal device 20′ over the image reading unit of the reading device 101 of the admission gate device 10 to present the image for authentication (Step S307). The reading device 101 reads the image for authentication displayed on the display unit 21 to output information of the read image.

In the description below, similarly to Step S308 to Step S311 explained with reference to FIG. 12, the authentication device 102 checks whether the user information has been extracted from the image information based on an analysis result of the image information output from the reading device 101 (Step S308). When the authentication device 102 determines that the user information has been extracted, the authentication device 102 performs authentication of the user information. When the authentication has been successful, the authentication device 102 checks the value of the admission flag corresponding to the user information. When the value of the admission flag is “OFF”, the authentication device 102 overwrites the value with “ON” (Step S309). Furthermore, the authentication device 102 checks whether the device ID has been extracted from the image information (Step S310).

When the authentication device 102 determines that the device ID has been extracted from the image information, the authentication device 102 transfers this device ID to the server 11′. The transferred device ID is received by the device management unit 110 in the server 11′ (Step S311). The device management unit 110, based on the device ID, starts connection establishment processing with the terminal device 20′ and adds an IP address to the terminal device 20′ (Step S321). When connection is established, the terminal device 20′ is enabled to communicate with the network 40 via the server 11′ (Step S313).

The processing at the time of leaving has no difference from the processing described at Step S400 to Step S403 in FIG. 12, and the description thereof thus will be omitted here.

As described above, in the second embodiment, the terminal device 20′ used by the invitee generates an image for authentication including the user information received by the invitee in advance and the device ID of the terminal device 20′ itself, and the invitee performs authentication processing related to admission in the admission gate device 10 using the image for authentication generated in the terminal device 20′ and connection processing to the network 40. With this, the invitee can use the terminal device 20′ connected to the network 40 without consciously performing authentication processing for the terminal device 20′. Furthermore, at the inviter side, there is no need to manually perform authentication of the invitee and the terminal device 20′.

Furthermore, in the second embodiment, the function of the image generation unit 200 needs to be mounted in the terminal device 20′ while the load of the server 11′ at the network system side can be decreased compared with a case in the first embodiment.

### Third Embodiment

Next, a third embodiment will be described. In the first embodiment described above, the image for authentication is displayed on the display unit 21 of the terminal device 20. By contrast, in the third embodiment, the image for authentication is printed on a printing medium, and the image for authentication printed on the printing medium is read by the reading device 101 of the admission gate device 10.

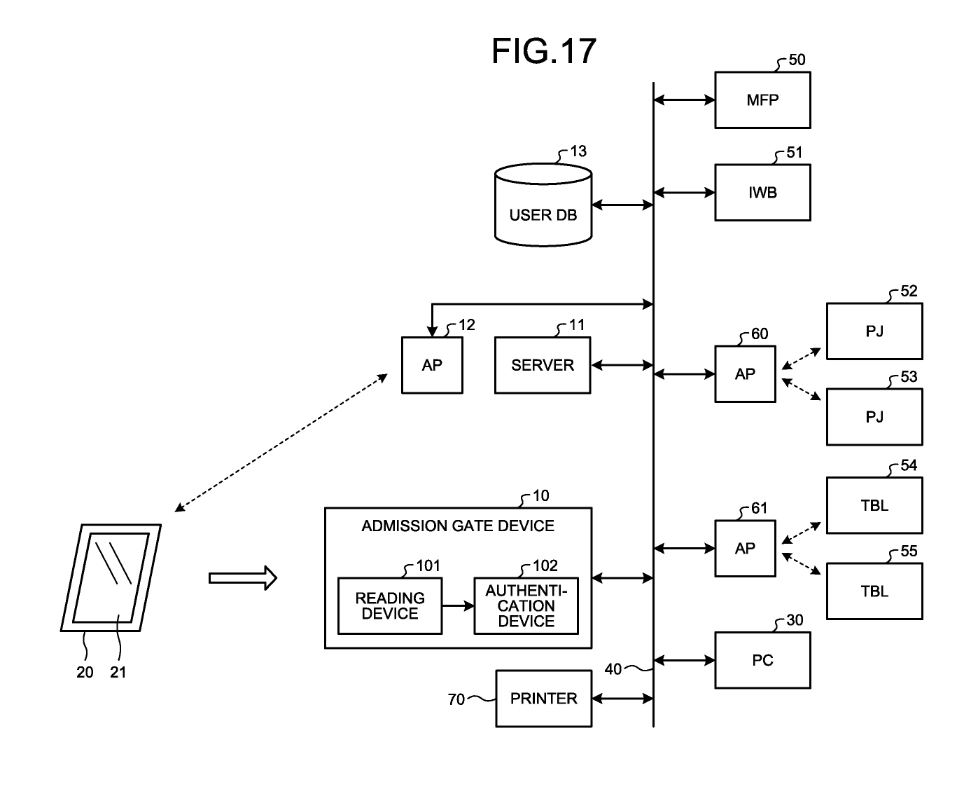

FIG. 17 illustrates an example of a network system applicable to a third embodiment of the present invention. It should be noted that in FIG. 17, the common parts to those in FIG. 1 described above are assigned with the same reference numerals, and the detailed explanations thereof are omitted.

In the network system according to the third embodiment exemplified in FIG. 17, a printer 70 connected to the network 40 is added, compared with the network system according to the first embodiment described with reference to FIG. 1. In this network system, with reference to FIG. 7, the server 11 causes the printer 70 to print on a printing medium the image for authentication generated by the image generation unit 112 based on the user information and the device ID transmitted from the terminal device 20 (at Step S11 in FIG. 7). The invitee puts the image for authentication printed on the printing medium over the reading unit of the reading device 101 of the admission gate device 10 (Step S13 in FIG. 7) so that the reading device 101 reads the image for authentication.

After that, similarly to the processing explained with reference to FIG. 7, the reading device 101 reads the image for authentication printed on the printing medium and outputs image information based on the image for authentication to the authentication device 102. The authentication device 102 extracts the user information and the device ID from the image information supplied from the reading device 101 and performs authentication processing based on the extracted user information. When the authentication has been successful, the authentication device 102 transfers the device ID extracted from the image information to the server 11 (Step S14 in FIG. 7). Furthermore, the authentication device 102 refers to the user DB 13 and causes the device ID to be stored in the record corresponding to the user information. In the server 11, the device management unit 110 establishes connection with the terminal device 20 based on the device ID transferred from the authentication device 102 (Step S15 in FIG. 7). With this, the terminal device 20 is enabled to perform communication with the network 40 via the server 11, and out of the devices connected to the network 40, a set device becomes usable.

As described above, in the third embodiment, the invitee transmits the user information received in advance to the network system and acquires from the network system the printing medium on which the image for authentication including the device ID and the user information is printed by the printer 70. The invitee then uses the image for authentication printed on the printing medium to perform authentication processing related to admission in the admission gate device 10 and connection processing to the network 40. With this, also in the third embodiment, the invitee can use the terminal device 20 connected to the network 40 without consciously performing authentication processing for the terminal device 20. Furthermore, at the inviter side, there is no need to manually perform authentication of the invitee and the terminal device 20.

Furthermore, in the third embodiment, the display unit 21 of the terminal device 20 does not need to be put over the reading unit of the reading device 101. With this, even in the case of using, as the terminal device 20, a device with which it is difficult to directly put its display unit 21 over the reading unit such as a notebook PC, admission processing and connection processing to the network 40 can be performed in the same manner as in the first embodiment.

### First Modification of the Third Embodiment

Next, a first modification of the third embodiment will be described. In the third embodiment described above, explanation has been made based on the printer 70 connected to the network 40. However, the present invention is not limited to this example. In the first modification of the third embodiment, the server 11 uses a printer connected to an external network communicable with the network 40 such as the Internet to print an image for authentication on a printing medium.

For example, in the first modification of the third embodiment, a network print service can be used, with which print data is transferred via the Internet to perform printing. Not only that, a printer in the invitee's home or office, for example, can be used for printing the image for authentication. For example, the server 11 places the image for authentication generated by the image generation unit 112 on a predetermined website on the Internet. The URL of the website may be described in the invitation mail, for example. The invitee uses a web browser in a PC in the invitee's home, for example, to access the website, causes the image for authentication to be displayed on the web browser, and prints the image for authentication.

In the network system according to the first modification of the third embodiment, the printer 70 for printing the image for authentication does not need to be connected to the network 40. Furthermore, the invitee can print the image for authentication in a place in which a network print service is provided (a predetermined store, for example) or in the invitee's home, whereby the freedom degree for acquiring the image for authentication is increased.

### Second Modification of the Third Embodiment

Next, a second modification of the third embodiment will be described. The second modification of the third embodiment is an example in which the second embodiment described above is combined with the third embodiment.

More specifically, in the second modification of the third embodiment, the invitee prints the image for authentication generated in the image generation unit 200 based on the user information described in the invitation mail and the device ID of the terminal device 20′ using a printer connected to the terminal device 20′. The invitee goes to the company office building of the inviter bringing the terminal device 20′ and the printing medium on which the image for authentication is printed and uses the image for authentication printed on the printing medium to perform authentication processing in the admission gate device 10 and connection processing to the network 40.

Also in the second modification of the third embodiment, the printer 70 for printing the image for authentication does not need to be connected to the network 40 in the network system. Furthermore, the invitee can print the image for authentication in the invitee's home, for example, whereby the freedom degree for acquiring the image for authentication is increased.

Exemplary embodiments of the present invention provide an advantage of enabling easy connection to a network system inside an organization from an information processing device of a user outside the organization while maintaining security.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An authentication system comprising:
a processor configured to perform:
generating an image including first identification information for identifying a user and second identification information for identifying a terminal device;
extracting the first identification information and the second identification information from image information acquired by reading the image using a reading device;
authenticating the first identification information extracted by the extraction unit; and
connecting the terminal device to a device via a network based on the extracted second identification information when authentication of the performed first identification information has been successful.

2. The authentication system according to claim 1, wherein the generating the image is performed based on the first identification information and the second identification information transmitted from the terminal device.

3. The authentication system according to claim 1, wherein the generating the image is performed in the terminal device.

4. The authentication system according to claim 1, wherein the processor further configured to perform:
transmitting the first identification information to the terminal device, wherein
the generating the image is performed by using the transmitted first identification information.

5. The authentication system according to claim 1, wherein
when the authenticating the first identification information is performed again in a state that the first identification information is authenticated, the authentication of the first identification information is canceled, and
connection from the terminal device to the network is released when the authentication of the first identification information is canceled from a state that the terminal device is connected to the network.

6. The authentication system according to claim 1, wherein the processor further configured to perform:
printing the image on a printing medium, wherein
the first identification information and the second identification information is extracted from the image information acquired by reading the image printed on the printing medium.

7. The authentication system according to claim 1, wherein
a connection device for connecting the terminal device to the network is placed inside a predetermined building, and
the reading device is an admission gate device for controlling admission to the building.

8. An authentication method comprising:
generating an image including first identification information for identifying a user and second identification information for identifying a terminal device;
reading the image using a reading device;
extracting the first identification information and the second identification information from image information acquired by reading at the reading;
authenticating the first identification information extracted at the extracting; and
connecting the terminal device to a device via a network based on the second identification information extracted at the extracting when authentication of the first identification information performed at the performing authentication has been successful.

9. The authentication method according to claim 8, wherein the generating the image is performed based on the first identification information and the second identification information transmitted from the terminal device.

10. The authentication method according to claim 8, wherein the generating the image is performed in the terminal device.

11. The authentication system according to claim 8, further comprising:
transmitting the first identification information to the terminal device, wherein
the generating the image is performed by using the transmitted first identification information.

12. The authentication method according to claim 8, wherein
when the authenticating the first identification information is performed again in a state that the first identification information is authenticated, the authentication of the first identification information is canceled, and
connection from the terminal device to the network is released when the authentication of the first identification information is canceled from a state that the terminal device is connected to the network.

13. The authentication system according to claim 8, further comprising:
printing the image on a printing medium, wherein
the first identification information and the second identification information is extracted from the image information acquired by reading the image printed on the printing medium.

14. The authentication method according to claim 8, wherein
a connection device for connecting the terminal device to the network is placed inside a predetermined building, and
the reading the image is performed by an admission gate device for controlling admission to the building.

15. A non-transitory computer-readable recording medium that contains an authentication program for causing a computer to execute:
extracting, from image information acquired by reading an image including first identification information for identifying a user and second identification information for identifying a terminal device using a reading device, the first identification information and the second identification information, and
authenticating the first identification information extracted at the extracting, and when the authentication has been successful, transferring the second identification information extracted at the extracting to a device management unit that controls connection from the terminal device to a device via a network based on the second identification information.
